(19) United States
(12) Patent Application Publication
(10) Pub. No.: US 2021/0003807 A1
(43) Pub. Date: Jan. 7, 2021

(54) MULTI-LENS MODULE STRUCTURE AND ELECTRONIC DEVICE HAVING SAME

(71) Applicant: TRIPLE WIN TECHNOLOGY(SHENZHEN) CO.LTD., Shenzhen (CN)

(72) Inventors: SHUAI-PENG LI, Shenzhen (CN); JING-WEI LI, Shenzhen (CN); SHENG-JIE DING, Shenzhen (CN); SHIN-WEN CHEN, New Taipei (TW)

(21) Appl. No.: 16/542,553

(22) Filed: Aug. 16, 2019

(30) Foreign Application Priority Data
Jul. 4, 2019 (CN) 201910601107.4

(51) Int. Cl. G02B 7/02; G02B 7/04

(52) U.S. Cl. CPC G02B 7/021; G02B 7/04

(57) ABSTRACT

A multi-lens module structure includes at least two lens modules and an antimagnetic structure. The anti-magnetic structure is located between the at least two lens modules.

### FIELD

The subject matter herein generally relates to a multi-lens module structure, and more particularly to a multi-lens module structure having a reduced size and improved magnetic interference prevention.

### BACKGROUND

Dual-camera or three-camera modules are increasingly used in electronic devices. However, magnets in the lenses are prone to magnetic interference, which affects a focusing speed and accuracy of the lens. If a distance between adjacent lenses is increased to reduce magnetic interference, an optical axis distance of the two lenses is increased accordingly, which not only affects assembly precision of the two lenses, but also reduces an overlap of the images taken by the two lenses, thereby affecting a shooting performance of the lenses.

### BRIEF DESCRIPTION OF THE DRAWINGS

Implementations of the present disclosure will now be described, by way of embodiments, with reference to the attached figures.

FIG. 1 is an assembled, isometric view of an embodiment of a multi-lens module structure.

FIG. 2 is an exploded view of the multi-lens module structure in FIG. 1.

FIG. 3 is an isometric view of an embodiment of an antimagnetic structure.

FIG. 4 is an isometric view of a bracket of the multi-lens module structure.

FIG. 5 is an isometric view of another embodiment of an antimagnetic structure.

FIG. 6 is a top-view of the multi-lens module structure.

FIG. 7 is a schematic view showing a difference between the multi-lens module structure and a multi-lens module structure in the related art.

FIG. 8 is an isometric view of an electronic device with the multi-lens module structure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

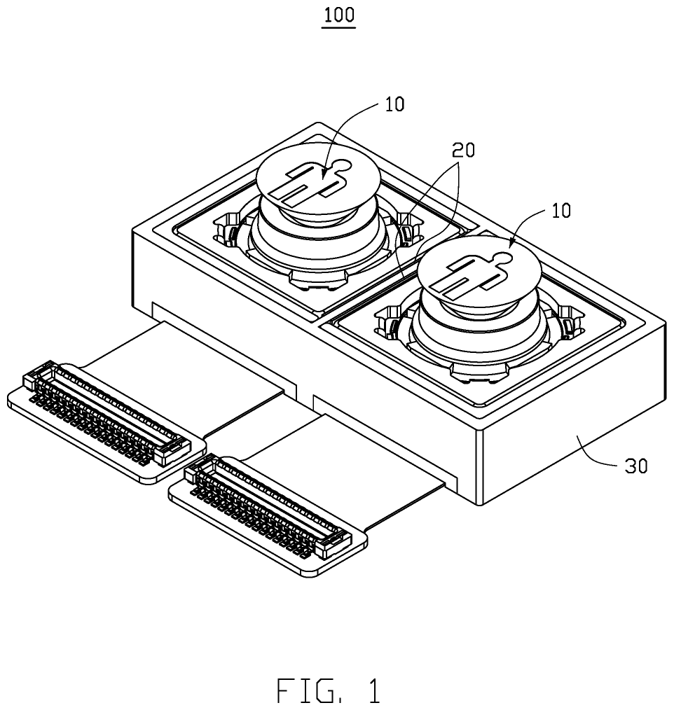

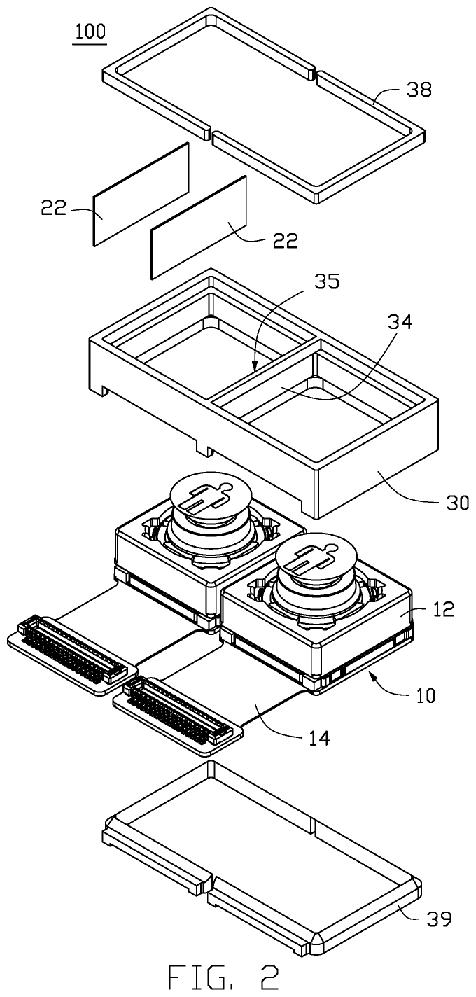

FIG. 1 and FIG. 2 show a schematic diagram of a multi-lens module structure 100. The multi-lens module structure 100 includes a bracket 30, at least two lens modules 10, an upper bracket adhesive 38, a lower bracket adhesive 39, and an antimagnetic structure 20.

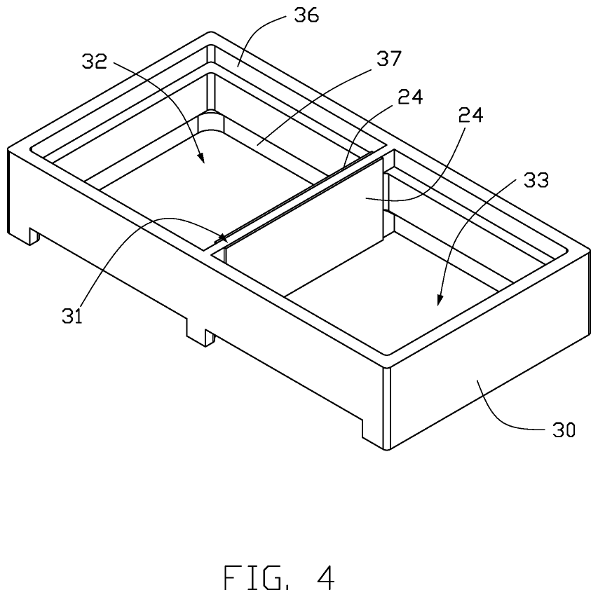

As shown in FIG. 4, the bracket 30 is substantially a hollow rectangular structure. The bracket 30 defines two through holes separated by a connecting portion 31. The connecting portion 31 is located in the middle of the bracket 30. The two through holes are a first through hole 32 and a second through hole 33.

As shown in FIG. 2, the multi-lens modules structure 100 includes two lens modules 10. Each lens module 10 includes a voice coil motor 12 and a circuit board 14 connected to the voice coil motor 12. The voice coil motor 12 has a substantially rectangular structure. The two voice coil motors 12 are respectively received in the first through hole 32 and the second through hole 33, and the two circuit boards 14 are respectively located outside the first through hole 32 and the second through hole 33.

The connecting portion 31 includes a first surface 34 and a second surface 35. The first surface 34 is opposite the second surface 35. The first surface 34 is located in the first through hole 32, and the second surface 35 is located in the second through hole 33. In one embodiment, the antimagnetic structure 20 includes at least two antimagnetic plates 22. The antimagnetic plates 22 are respectively attached to the first surface 34 and the second surface 35. The antimagnetic plates 22 are used to prevent magnetic interference between the two lens modules 10 during operation.

As shown in FIG. 4, the bracket 30 defines a first recessed portion 36 and a second recessed portion 37 in the first through hole 32 and the second through hole 33. The first recessed portion 36 and the second recessed portion 37 are respectively located adjacent to opposite openings of the first through hole 32 and the second through hole 33. The first recessed portion 36 receives the upper bracket adhesive 38, and the second recessed portion 37 receives the lower bracket adhesive 39. The upper bracket adhesive 38 and the lower bracket adhesive 39 fix the two lens modules 10 to the bracket 30 to assemble the multi-lens module structure 100.

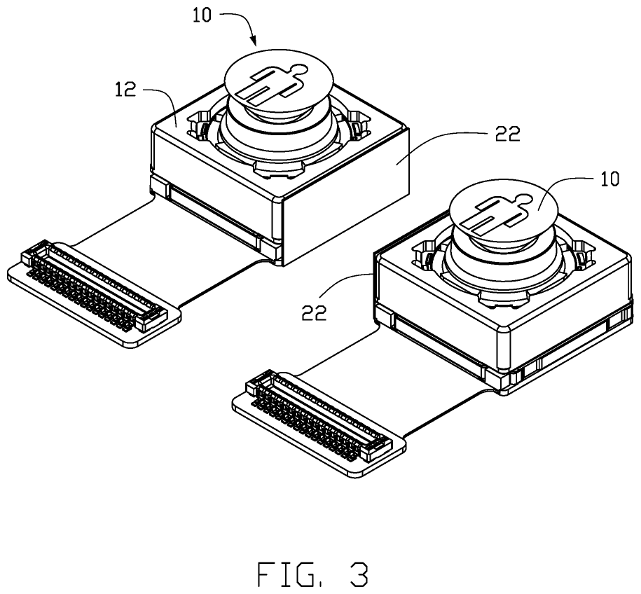

As shown in FIG. 3, in another embodiment, the antimagnetic plates 22 are attached to the two voice coil motors 12, respectively. Specifically, the antimagnetic plates 22 are respectively attached to the surfaces of the voice coil motors 12 adjacent to the first surface 34 and the second surface 35.

In another embodiment, the antimagnetic plates 22 are replaced with an antimagnetic coating 24.

Specifically, as shown in FIG. 4, plasma treatment or electric spark treatment is performed on the first surface 34 and the second surface 35 to increase a surface roughness of the first surface 34 and the second surface 35 and to improve adhesion to the first surface 34 and the second surface 35. Then, the antimagnetic coating 24 is applied on the first surface 34 and the second surface 35.

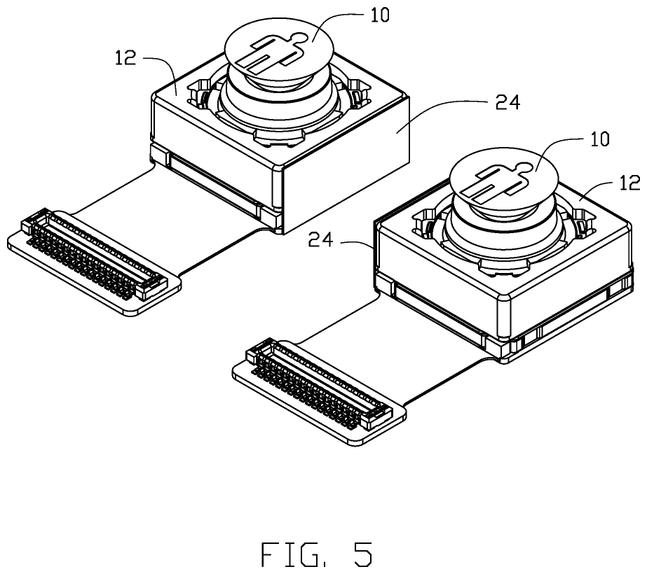

As shown in FIG. 5, in another embodiment, the antimagnetic coating 24 is applied on a surface of the voice coil motors 12 adjacent to the first surface 34 and the second surface 35, respectively.

In other embodiments, the antimagnetic plates 22 and the antimagnetic coating 24 can be applied at the same time between the two lens modules 10.

In another embodiment, the antimagnetic plates 22 and/or the antimagnetic coating 24 are applied surrounding the voice coil motors 12 of the lens modules 10. The antimagnetic plates 22 and/or the antimagnetic coating 24 prevent magnetic interference between the two lens modules 10 and prevent magnetic interference between the lens modules 10 and adjacent electronic components, such as an earpiece, a speaker, an antenna, or the like.

In other embodiments, the multi-lens module structure 100 may include three, four, or more lens modules 10, such that the antimagnetic structure 20 is located between each two adjacent lens modules 10.

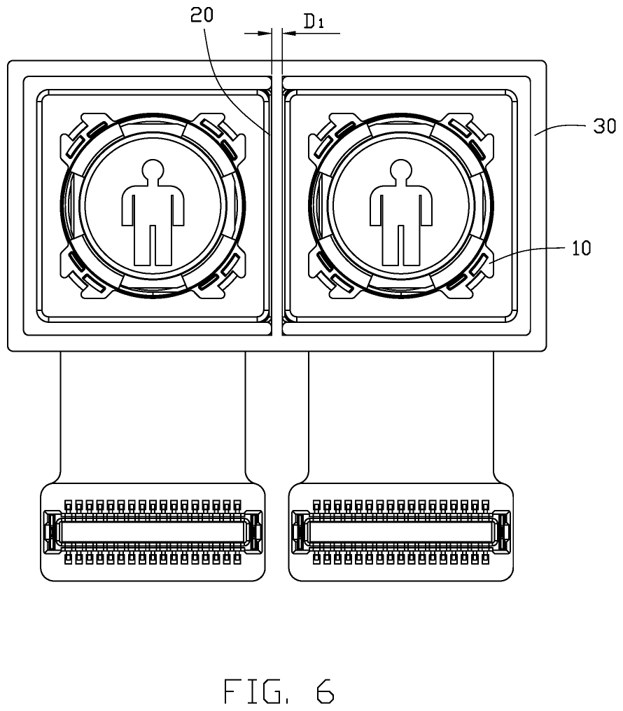

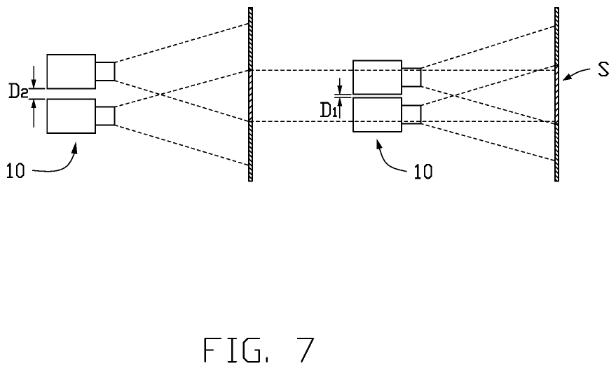

Referring to FIG. 6 and FIG. 7, the antimagnetic structure 20 can effectively reduce a separation distance between the two lens modules 10. In one embodiment, a separation distance D1 between the lens modules 10 is 0.4 mm. In the related art, magnetic interference is reduced by increasing the separation distance between the adjacent lens modules. As shown in FIG. 7, a separation distance D2 in the related art reaches 1 mm. With the antimagnetic structure 20, a composite image overlapping area S of the two lens modules 10 is effectively improved, thereby improving an overlap degree of a composite image. The higher the overlapping degree of the composite image, the better the photographing effect.

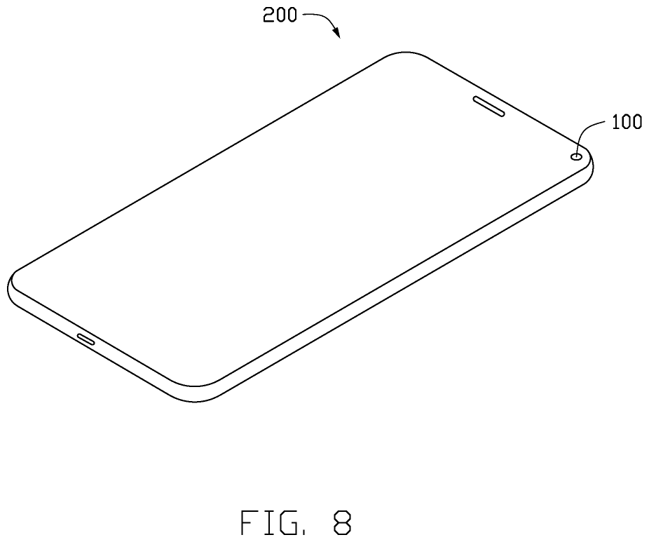

As shown in FIG. 8, the multi-lens module structure 100 is applied in an electronic device 200. The electronic device 200 can be a mobile phone, a tablet computer, a monitoring device, or a vehicle.

The multi-lens module structure 100 not only prevents magnetic interference between the two lens modules 10 by providing the antimagnetic structure 20, the separation distance D1 between the two lens modules 10 is effectively reduced, thereby improving the photographing effect of the multi-lens module structure 100 and improving a miniaturization design of the multi-lens module structure 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A multi-lens module structure comprising:
at least two lens modules; and
an antimagnetic structure located between the at least two lens modules.

2. The multi-lens module structure of claim 1, further comprising a bracket which is hollowed, wherein:
the bracket comprises at least one connecting portion separating the bracket into at least two through holes;
each of the at least two lens module comprises a voice coil motor; and
each voice coil motor is received in a respective through hole.

3. The multi-lens module structure of claim 2, wherein:
the connecting portion comprises a first surface and a second surface;
the first surface is opposite the second surface;
the first surface is located in one of the through holes, and the second surface is located in another one of the through holes.

4. The multi-lens module structure of claim 3, wherein:
the antimagnetic structure comprises a plurality of antimagnetic plates; and
the antimagnetic plates are attached to the first surface and the second surface.

5. The multi-lens module structure of claim 3, wherein:
the antimagnetic structure is an antimagnetic coating; and
the antimagnetic coating is applied on the first surface and the second surface.

6. The multi-lens module structure of claim 2, wherein:
the antimagnetic structure comprises a plurality of antimagnetic plates;
the antimagnetic plates are attached to at least one of the lens modules on a surface of the lens module adjacent to the connecting portion.

7. The multi-lens module structure of claim 2, wherein:
the antimagnetic structure is an antimagnetic coating; and
the antimagnetic coating is applied on at least one of the voice coil motors on a surface of the voice coil motor adjacent to the connecting portion.

8. The multi-lens module structure of claim 2, further comprising an upper bracket adhesive and a lower bracket adhesive, wherein:
the bracket defines a first recessed portion and a second recessed portion in each of the through holes;
the first recessed portion and the second recessed portion are respectively located adjacent to opposite openings of the through holes; and
the first recessed portion receives the upper bracket adhesive, and the second recessed portion receives the lower bracket adhesive.

9. The multi-lens module structure of claim 2, wherein:
the antimagnetic structure surrounds the voice coil motors; and
the antimagnetic structure is located on each surface of the voice coil motor in the through holes.

10. The multi-lens module structure of claim 1, wherein:
a separation distance between adjacent two lens modules is less than 1 mm.

11. An electronic device comprising a multi-lens module structure comprising:
at least two lens modules; and
an antimagnetic structure located between the at least two lens modules.

12. The electronic device of claim 11, wherein:
the multi-lens module structure further comprises a bracket which is hollow;
the bracket comprises at least one connecting portion separating the bracket into at least two through holes;
each of the lens modules comprises a voice coil motor; and
each voice coil motor is received in a respective through hole.

13. The electronic device of claim 12, wherein:
the connecting portion comprises a first surface and a second surface;
the first surface is opposite the second surface;
the first surface is located in one of the through holes, and the second surface is located in another one of the through holes.

14. The electronic device of claim 13, wherein:
the antimagnetic structure comprises a plurality of antimagnetic plates; and
the antimagnetic plates are attached to the first surface and the second surface.

15. The electronic device of claim 13, wherein:
the antimagnetic structure is an antimagnetic coating; and
the antimagnetic coating is applied on the first surface and the second surface.

16. The electronic device of claim 12, wherein:
the antimagnetic structure comprises a plurality of antimagnetic plates;
the antimagnetic plates are attached to at least one of the lens modules on a surface of the lens module adjacent to the connecting portion.

17. The electronic device of claim 12, wherein:
the antimagnetic structure is an antimagnetic coating; and
the antimagnetic coating is applied on at least one of the voice coil motors on a surface of the voice coil motor adjacent to the connecting portion.

18. The electronic device of claim 12, wherein:
the multi-lens module structure further comprises an upper bracket adhesive and a lower bracket adhesive;
the bracket defines a first recessed portion and a second recessed portion in each of the through holes;
the first recessed portion and the second recessed portion are respectively located adjacent to opposite openings of the through holes; and
the first recessed portion receives the upper bracket adhesive, and the second recessed portion receives the lower bracket adhesive.

19. The electronic device of claim 12, wherein:
the antimagnetic structure surrounds the voice coil motors; and
the antimagnetic structure is located on each surface of the voice coil motor in the through holes.

20. The electronic device of claim 11, wherein:
a separation distance between adjacent two lens modules is less than 1 mm.
